(19) United States
(12) Patent Application Publication
(10) Pub. No.: US 2003/0220135 A1
(43) Pub. Date: Nov. 27, 2003

(54) Gaming device with randomly determined bonus award possibilities

(76) Inventor: Michael Gauselmann, Espelkamp (DE)

Correspondence Address: PATENT LAW GROUP LLP, 2635 NORTH FIRST STREET, SUITE 223, SAN JOSE, CA, 95134, US

(21) Appl. No.: 10/153,367

(22) Filed: May 22, 2002

(51) Int. Cl. A63F 13/00

(52) U.S. Cl. 463/25

(57) ABSTRACT

In one embodiment, a gaming machine comprises a standard gaming machine portion displaying rotating reels, where the reels (physical or simulated) are randomly stopped, and an award is based upon the final symbol combination. Upon a special symbol combination being obtained in the main game, a secondary (or bonus) game is then carried out by the machine. In one embodiment, the bonus game comprises a display that randomly displays a plurality (e.g., five) of possible bonus values. In a second phase of the bonus game, one of the displayed possible bonuses is randomly selected for being paid to the player. Many other implementations of a bonus game that randomly generates possible bonuses and randomly selects one of the bonuses for payment to the player are envisioned.

### FIELD OF INVENTION

This invention is related to gaming machines and, in particular, to a bonus game in a gaming machine, such as a slot machine.

### BACKGROUND

A typical gaming machine found in casinos carries out a single game, such as displaying rotating reels having symbols, where the resulting symbol combinations correspond to awards to be paid to the player. Many newer gaming machines provide a bonus game where, for a special symbol combination, a secondary (or bonus) game is played that is different from the main game. This bonus game adds player excitement and, thus, results in a more popular and profitable gaming machine.

In one form of bonus game, a special wheel, having all the bonus amounts printed on it, spins and randomly stops to award a bonus amount to the player. One drawback of such a bonus game that presents a fixed set of bonus possibilities to the player is that the possible bonus values cannot be too large or else the machine becomes unprofitable, since a large bonus amount would be available to be won each time the bonus game is played.

Gaming machines that offer the player the possibility of obtaining a very large award (such as a progressive jackpot award) are very popular due to the slim possibility that the player may win a very large award.

Thus, what is needed is a gaming machine that can offer the player a potentially very high bonus award while the machine remains profitable.

### SUMMARY

In one embodiment, a gaming machine carrying out the present invention comprises a standard gaming machine portion displaying rotating reels (either physical reels or on a video screen), where the reels are then randomly stopped, and an award is given based upon the final symbol combination. Upon a special symbol combination being obtained in the main game, a secondary (or bonus) game is then carried out by the machine. In one embodiment, a physically separate portion of the machine carries out and displays the bonus game. This physically separate portion contains its own CPU and other electronics so that the bonus portion of the machine can be added onto a conventional gaming machine, and only simple commands from the main game's CPU are required for the bonus game's CPU to carry out the bonus game.

In one embodiment, the bonus game comprises a display that displays a randomly selected plurality of possible bonus values. The possible bonus values can be randomly determined using a pseudo-random number generator. The plurality of possible bonus values (e.g., five values) can range from low to very high, and the very high bonus values may only be selected infrequently by the random number generator. Various types of bonus indicia may be displayed such as award values, award multipliers, and symbols.

In the second phase of the bonus game, one of the displayed possible bonus values is randomly selected for being paid to the player. In one embodiment, the random selection is identified by an arrow identifying one of the displayed bonus values.

Many other implementations of a bonus game that randomly generates possible bonuses and then randomly selects one of the bonuses for payment to the player are envisioned. The gaming machine can advertise to the player the possibility of very high bonuses, although infrequently available, thus enabling the machine to entice players and be profitable. Further, by not providing the possibility of winning a very high bonus for each bonus game, the bonus game can be activated more frequently by the machine, thus increasing player excitement.

### BRIEF DESCRIPTION OF THE DRAWINGS

FIG. 1 is a perspective view of one embodiment of a gaming machine incorporating the present invention.

FIG. 2 is the gaming machine of FIG. 1 displaying the randomly selected bonus award possibilities.

FIG. 3 illustrates the gaming machine of FIG. 2 after one of the bonuses has been randomly selected by the machine.

FIG. 4 is a block diagram illustrating various components of the main game portion and the bonus game portion.

FIG. 5 illustrates a display of a randomly selected wheel for identifying a bonus award.

FIG. 6 illustrates a display of a plurality of wheels for identify a possible bonus award, where the bonus award is ultimately selected by a randomly controlled indicator.

### DETAILED DESCRIPTION

Although the invention can typically be implemented by installing a software program in most types of modem video gaming machines, where the main game and bonus game are displayed on a single video screen, one particular gaming machine platform having a “top box” specifically designed for conducting the bonus game will be described in detail.

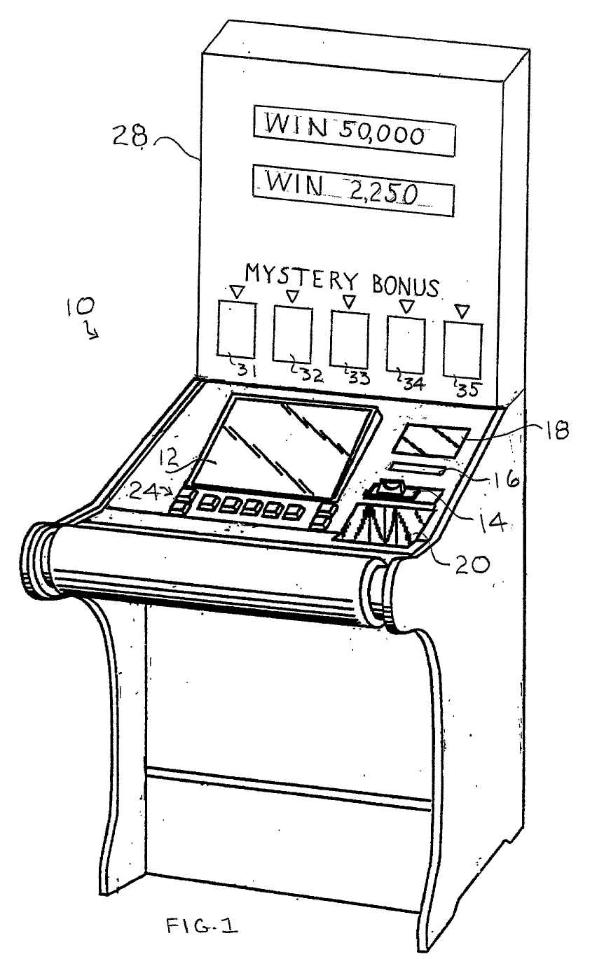

FIG. 1 is a perspective view of a gaming machine 10 that incorporates the present invention. Machine 10 includes a display 12 that may be a thin film transistor (TFT) display, a liquid crystal display (LCD), a cathode ray tube (CRT), or any other type of display. Display 12 may include a touch screen for converting a player's touching of areas of the screen into commands for the game program to carry out. Display 12 may also be a window revealing rotating reels.

A coin slot 14 accepts coins or tokens in one or more denominations to generate credits within machine 10 for playing games. An input slot 16 is also provided for receiving either bills, machine readable printed tickets, cashless gaming cards, smart cards, or other types of media for generating credits within machine 10. A display 18 may identify instructions to the player for depositing money or monetary equivalents into machine 10.

A coin tray 20 is provided for receiving coins or tokens from a hopper upon a win or upon the player cashing out.

Player control buttons 24 include any buttons needed for the play of the particular game or games offered by machine 10 including, for example, a bet button, a repeat bet button, a play two-ways button, a spin reels button, a deal button, hold card buttons, a draw button, a maximum bet button, and cash-out button, and any other suitable buttons for the main game offered by machine 10. Buttons 24 may be replaced by a touch screen with virtual buttons.

Since the invention particularly relates to a bonus game, the main game may be virtually any type of game where at least one of the outcomes of the main game activates or enables playing of the bonus game. A typical main game will be a plurality of rotating reels displayed on the video display 12 whose stop positions are determined by a pseudo random number generator. A CPU in machine 10 controls a display controller to stop the simulated rotation of the reels to display the symbol combination previously selected by the random number generator. As would be advertised on display 12 or on a display glass, such as in the top box portion 28, one or more special combinations of symbols activate the bonus game. The special combination of symbols may include certain special symbols that may read “MYSTERY BONUS.” A certain signal is then generated when such a special outcome occurs in the main game to activate the bonus game. Such a signal may be a particular code generated by a pay table ROM or the CPU that results when the special symbol combination is present. The hardware and software used to identify the outcome of a main game are well known and conventional and need not be described in detail.

Other types of main games, such as card games, and other games of chance, may be used instead of simulated rotating reels.

Upon generating a signal indicating the outcome of the special symbol combination, a CPU in the lower portion of gaming machine 10 or in the top box 28 randomly generates signals to display five bonus amounts (or other indicia) in display areas 31-35. The display of the five bonus amounts may also be activated by the player pressing a button. Instead of bonus amounts (money or credits) being displayed, the display areas 31-35 may display any other indicia, such as multipliers, symbols (including words and icons), or a combination of awards, multipliers, and symbols.

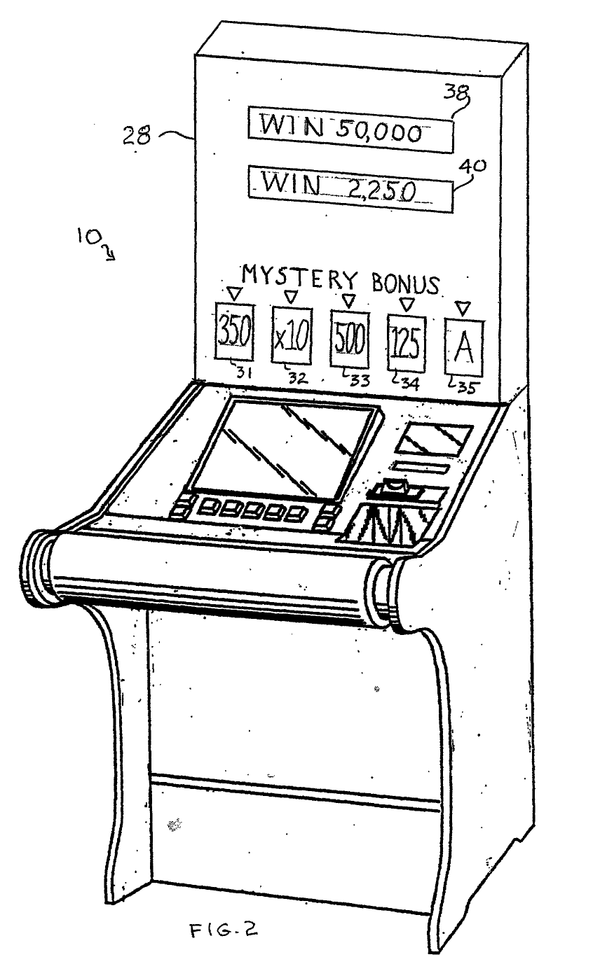

In the example shown in FIG. 2, a combination of randomly selected indicia is displayed in areas 31-35. The indicia randomly selected by machine 10 are 350 credits, a ×10 multiplier, 500 credits, 125 credits, and a symbol. Any of the display areas 31-35 could be designed to display any of the indicia. The CPU controlling the random generation of the possible bonus indicia may weight the random number generator such that is less likely to display a very valuable bonus than a medium value bonus. In this way, the largest bonus award may be advertised on the display glass of machine 10 but not be available to the player every time a bonus game is played. Accordingly, the benefits of offering a very large bonus are achieved without reducing the profitability of the machine. Further, by having lower bonus values more frequently selected by the random number generator, the bonus game can be enabled more frequently while still being profitable for the casino.

An additional display 38 identifies to players the highest possible win achievable on machine 10, and display 40 displays any other value. In one embodiment, display 38 identifies the current progressive jackpot amount, and display 40 displays another special jackpot amount.

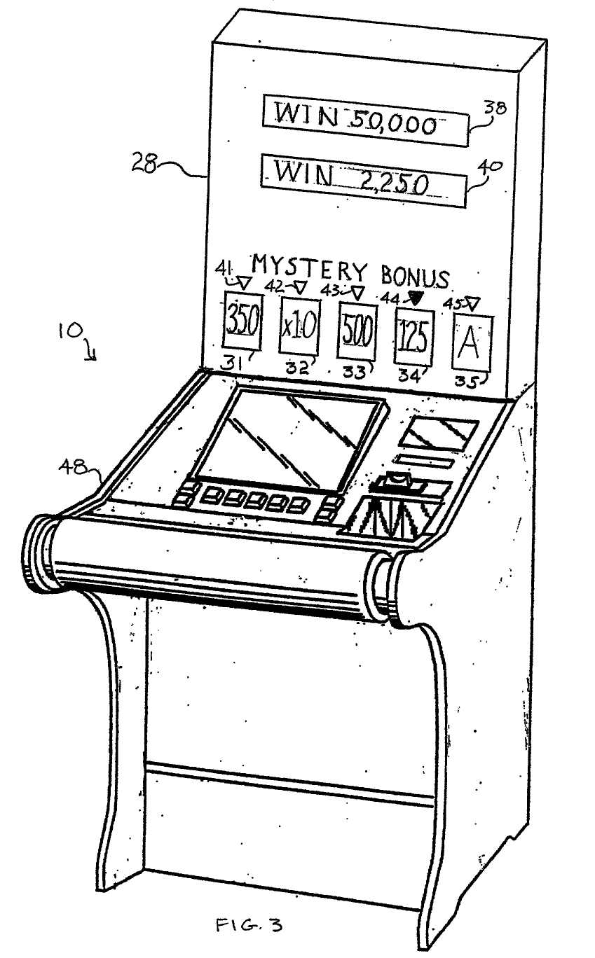

In the next phase of the bonus game shown in FIG. 3, indicators 41-45 are sequentially illuminated, and a random number generator selects the final illuminated indicator which, in this case, is indicator 44. Thus, as shown in FIG. 3, the player has won a bonus of 125 credits. The indicators may be translucent arrows backlit by LEDs or may be any other type of indicator, such as bulbs illuminating the selected bonus amount.

The bonus game may then end or continue with a new set of possible bonus indicia being displayed in areas 31-35.

The bonus game may involve a plurality of rounds of the bonus game such as where the player needs to “collect” three of the same symbol in five rounds of the bonus game. Many other types of games may be played by first randomly selecting a set of possible bonus indicia that may vary from game to game and then randomly selecting one of the bonus indicia.

In one example, the bonus game is five rounds. In the first round, flip cards (or another display) may display 125 credits, ×3, a joker symbol, a jackpot symbol, and a free game(s) icon. A multiplier may multiply an award identified by the main game or multiply another award. A joker symbol represents a wild card symbol that can be combined with any other symbol to obtain a winning combination of symbols in the five rounds. If the player gets five jackpot symbols, the player wins a large jackpot. The indicator then selects one of the displayed indicia for an “award” to the player. The next round then automatically commences. The awards “won” during the bonus game may be displayed in a separate display. Each of the flip card modules may contain 70 or more cards, so there are many different combinations of indicia, and the likelihood of displaying a particular bonus indicia may be weighted by selection of the number of cards for that particular indicia in the flip cards.

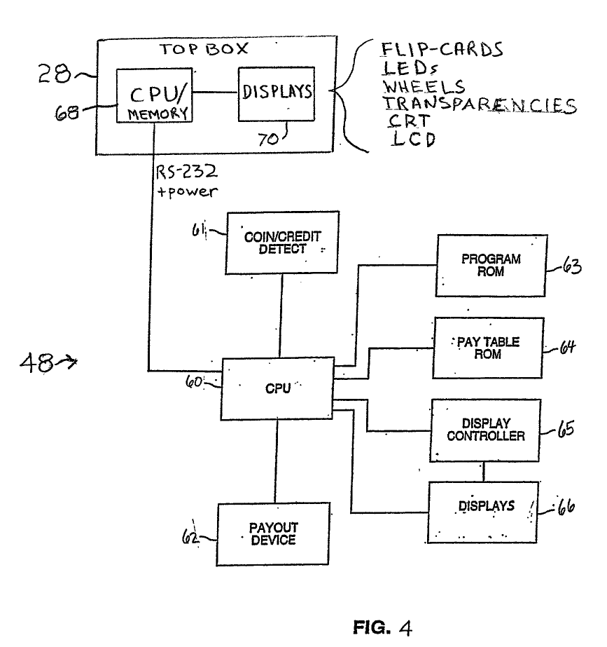

FIG. 4 is a block diagram illustrating basic functional blocks in the lower portion 48 of gaming machine 10 and in the top box 28 of machine 10. A CPU 60 runs a gaming program stored in a program ROM 63. CPU 60 also uses a conventional RAM. A coin-credit detector 61 generates credits to play the game. A payout device 62 pays out an award to the player in the form of coins upon termination of the game or upon the player cashing out. A payout may also be in the form of a coded paper ticket, credits on a smart card or magnetic strip card, or in any other form. A pay table ROM 64 receives signals corresponding to the outcome of the game and identifies the award to be paid to the player by the payout device 62. A display controller 65 receives command from CPU 60 and generates signals for any display 66 (such as display 12 in FIG. 1). If a display is a touch screen, player commands may be input through the display screen to CPU 60.

Upon a special combination of symbols being generated in the main game (or upon any other special outcome of the main game), signals from the CPU 60 are transmitted via an RS-232 interface to electronics located in the top box 28 for carrying out the bonus game. By separating the electronics for the top box 28 from the electronics in the lower portion of the machine, the lower portion of the machine may be made generic so it can be used in combination with various other types of top boxes conducting different forms of bonus games. Additionally, the programming of the bonus game may be changed independently of the programming for the main game.

In one embodiment, upon the special outcome of the main game, the CPU 60 randomly generates signals for the five display areas 31-35 and transmits these signals to CPU 68 in the top box 28. The CPU 68 (coupled to any type of RAM and ROM containing the bonus gaming program) then carries out the bonus gaming routine contained in the memory to control the various displays in the top box 28. Any other division of the bonus game function may be made between CPU 60 and CPU 68.

The displays for areas 31-35 in the top box 28 are referred to as displays 70 in FIG. 4. The various displays 70 may include flip-cards, LEDs, wheels, transparencies, CRTs, LCDs or any combination of such displays or any other known displays. Flip cards are of the type well known in the art of gaming, digital clocks, and signs, where thin printed cards pivoting around a common axis are flipped by a motor until the selected card is displayed. Such flip card displays are commercially available, as are the other types of displays.

Additionally, in one embodiment, the top box 28 may have control buttons for the player, such as one button for the player to start flipping the cards in the first phase of the game and another button to initiate ending the sequencing of the indicators 41-45. The outcome will still be random, however. Such initiation of the various phases may also be performed automatically by the CPU 68.

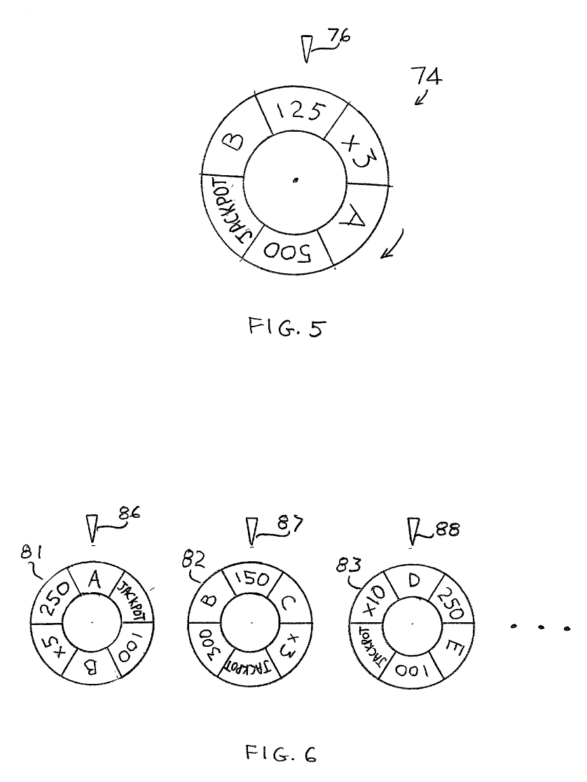

Another type of display, shown in FIG. 5, may be a video representation of a rotating wheel 74 with various awards, symbols, and multipliers identified on its periphery. The wheel 74 is randomly stopped, and a fixed indicator 76 points to the prize. The displayed wheel may be one of a plurality of wheels in a memory randomly chosen, where each wheel has a different combination of possible awards.

In another embodiment, shown in FIG. 6, a plurality of physical or video wheels 81, 82, 83 are displayed, with each wheel having the same type or different types of indicia. Each wheel is randomly stopped to identify a possible indicium to be selected. Indicators 86, 87, 88 then randomly select one of the indicia on the plurality of stopped wheels. Any form of indication may be used.

The display for the secondary game may be the same display 12 for the main game.

While particular embodiments of the present invention have been shown and described, it would be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A gaming method comprising:
displaying a main game, the main game having a plurality of possible outcomes, at least one of the outcomes enabling a secondary game;
after the main game generates said at least one of the outcomes, enabling the secondary game, the secondary game comprising:
selecting a plurality of M indicia from a set of N indicia, where N is greater than M;
displaying the M indicia to a player; and
randomly selecting one of the M indicia as at least a partial outcome of the secondary game.

2. The method of claim 1 wherein the M indicia include award values.

3. The method of claim 2 wherein the award values include game credits.

4. The method of claim 2 wherein the award values include monetary amounts.

5. The method of claim 1 wherein the M indicia include symbols to be collected by a player to obtain combinations of symbols.

6. The method of claim 1 wherein selecting a plurality of M indicia comprises randomly selecting a plurality of M indicia from the set of N indicia.

7. The method of claim 6 wherein the randomly selecting a plurality of M indicia comprises pseudo-randomly selecting a plurality of M indicia using a pseudo random number generator.

8. The method of claim 1 wherein displaying the M indicia comprises displaying each of the M indicia in a different display area.

9. The method of claim 1 wherein displaying the M indicia comprises displaying the M indicia using flip cards.

10. The method of claim 1 wherein displaying the M indicia comprises displaying the M indicia with LEDs.

11. The method of claim 1 wherein displaying the M indicia comprises displaying the M indicia with wheels.

12. The method of claim 1 wherein displaying the M indicia comprises displaying the M indicia with backlit transparencies.

13. The method of claim 1 wherein displaying the M indicia comprises displaying the M indicia with one or more CRTs.

14. The method of claim 1 wherein displaying the M indicia comprises displaying the M indicia with one or more LCDs.

15. The method of claim 1 wherein randomly selecting one of the M indicia comprises selecting one of the displayed M indicia with an indicator.

16. The method of claim 15 wherein the indicator comprises M indicators, each associated with a particular one of the M indicia, the method further comprising sequencing the indicators and subsequently illuminating only one indicator so as to identify a particular one of the M indicia.

17. The method of claim 1 further comprising receiving a signal by a player pressing a button to initiate the displaying of the M indicia.

18. The method of claim 1 wherein selecting the plurality of M indicia occurs prior to displaying the M indicia.

19. The method of claim 1 wherein displaying a main game comprises:
carrying out a program for the main game by a first CPU;
generating signals by the first CPU upon the occurrence of said at least one of the outcomes enabling the secondary game;
receiving the signals by a second CPU for carrying out at least a portion of the secondary game; and
controlling, by the second CPU, the displaying of the M indicia.

20. The method of claim 1 wherein:
displaying the main game is performed in a lower portion of a gaming device; and
displaying the M indicia is performed by a top box added on to the lower portion of the gaming machine.

21. The method of claim 1 wherein the main game comprises displaying simulated reels on a video screen, wherein at least one symbol combination enables the secondary game.

22. The method of claim 1 wherein the M indicia include different kinds of indicia.

23. The method of claim 22 wherein the different kinds of indicia comprise award values and multiplier values.

24. The method of claim 22 wherein the different kinds of indicia comprise award values and symbols to be combined with other symbols.

25. The method of claim 1 wherein the M indicia comprise indicia to be collected to obtain combinations of indicia, one or more certain combinations of indicia providing the player an award.

26. The method of claim 25 wherein the award is a jackpot.

27. The method of claim 1 wherein displaying the M indicia comprises displaying the M indicia with one or more wheels, the method further comprising rotating and stopping the one or more wheels to identify one indicia on each of the one or more wheels.

28. The method of claim 27 where the one or more wheels comprise a single wheel, the method further comprising randomly selecting indicia for appearing on the wheel.

29. The method of claim 27 wherein the one or more wheels comprise a plurality of wheels, the method further comprising randomly selecting one of the indicia on the wheels.

30. The method of claim 27 wherein displaying the M indicia comprises displaying the M indicia on a video screen.

31. A gaming device comprising:
a display area for displaying a main game, the main game having a plurality of possible outcomes, at least one of the outcomes enabling a secondary game; and
at least one processor and display for displaying the secondary game, the secondary game comprising:
selecting a plurality of M indicia from a set of N indicia, where N is greater than M;
displaying the M indicia to a player; and
randomly selecting one of the M indicia as at least a partial outcome of the secondary game.

32. The device of claim 31 wherein the M indicia include award values.

33. The device of claim 31 wherein the M indicia include symbols to be collected by a player to obtain combinations of symbols.

34. The device of claim 31 wherein selecting a plurality of M indicia comprises randomly selecting a plurality of M indicia from the set of N indicia.

35. The device of claim 34 further comprising a pseudo-random number generator for selecting a plurality of M indicia.

36. The device of claim 31 further comprising a different display area for each of the M indicia.

37. The device of claim 31 further comprising flip cards for displaying the M indicia.

38. The device of claim 31 further comprising an indicator for selecting one of the M indicia.

39. The device of claim 38 wherein the indicator comprises M indicators, the M indicators being sequenced, and the sequencing then stopped so as to identify a particular one of the M indicia.

40. The device of claim 31 further comprising:
a first CPU for carrying out a program for the main game, the first CPU generating signals upon the occurrence of said at least one of the outcomes enabling the secondary game; and
a second CPU for receiving the signals for carrying out at least a portion of the secondary game and for controlling displaying the M indicia.

41. The device of claim 40 wherein the first CPU transmits signals to the second CPU identifying the M indicia, wherein the first CPU is located in a lower portion of a gaming device, and the second CPU is located in a top box added on to the lower portion of the gaming device.

42. The device of claim 40 wherein the main game comprises simulated reels on a video screen, wherein at least one symbol combination enables the secondary game.
